(19) United States
(12) Patent Application Publication
(10) Pub. No.: US 2021/0329535 A1
(43) Pub. Date: Oct. 21, 2021

(54) (DE)ACTIVATING COVERAGE ENHANCEMENT ON A USER EQUIPMENT (UE) BASED ON A LOCATION OF THE UE

(71) Applicant: FG Innovation Company Limited, Tuen Mun (HK)

(72) Inventors: CHIE-MING CHOU, Taipei (TW); HSIN-HSI TSAI, Taipei (TW); HAI-HAN WANG, Taipei (TW); CHIA-HUNG WEI, Taipei (TW); MEI-JU SHIH, Taipei (TW); YUNG-LAN TSENG, Taipei (TW)

(21) Appl. No.: 17/231,418

(22) Filed: Apr. 15, 2021

Related U.S. Application Data
(60) Provisional application No. 63/010,605, filed on Apr. 15, 2020.

(51) Int. Cl. H04W 48/04; H04W 4/021

(52) U.S. Cl. CPC H04W 48/04; H04W 4/021

(57) ABSTRACT

A method for a user equipment (UE) configured with coverage enhancement configuration is provided. The method receives first data associated with ultra-reliable and low-latency communications (URLLC) traffic to be transmitted to a serving cell. The method then determines whether the UE is within a URLLC coverage area. Upon determining that the UE is within the URLLC coverage area, the method deactivates the coverage enhancement configuration before transmitting the first data to the serving cell.

### CROSS-REFERENCE TO RELATED APPLICATION(S)

The present application claims the benefit of and priority to a provisional U.S. Patent Application Ser. No. 63/010,605, filed on Apr. 15, 2020, entitled “Method and Apparatus for Handling UE Behavior under Coverage Enhancement,” with Attorney Docket No. US81144 (hereinafter referred to as “US81144 application”). The disclosure of the US81144 application is hereby incorporated fully by reference into the present application.

### FIELD

The present disclosure generally relates to wireless communications, and more particularly, to determine whether to activate coverage enhancement configuration for a user equipment (UE) in the next generation wireless networks.

### BACKGROUND

With the tremendous growth in the number of connected devices and the rapid increase in user/network traffic volume, various efforts have been made to improve different aspects of wireless communication for the next-generation wireless communication system, such as the fifth-generation (5G) New Radio (NR), by improving data rate, latency, reliability, and mobility.

The 5G NR system is designed to provide flexibility and configurability to optimize the network services and types, accommodating various use cases, such as enhanced Mobile Broadband (eMBB), massive Machine-Type Communication (mMTC), and Ultra-Reliable and Low-Latency Communication (URLLC). Communication devices, such as UEs and base stations communicate with each other and with other devices in a 5G NR communication system leveraging high frequency radio bands. Using high frequency radio bands may result in shorter coverage area, which could be a concern for voice over internet protocol (VoIP) and eMBB services (e.g., especially in uplink (UL) transmissions). To address this issue some mechanisms have been introduced (e.g., by 3rd Generation Partnership Project (3GPP)) to enhance the coverage area, for example, by increasing the number of repetitions. Such mechanisms, however, have their own shortcomings. For example, increasing the number of repetitions may also increase the latency.

### SUMMARY

The present disclosure is directed to activating or deactivating coverage enhancement configuration in a user equipment (UE) based on the location of the UE.

In a first aspect of the present application, a method for a UE configured with coverage enhancement configuration is provided. The method includes receiving first data associated with ultra reliable and low latency communications (URLLC) traffic to be transmitted to a serving cell; determining whether the UE is within a URLLC coverage area; and deactivating the coverage enhancement configuration before transmitting the first data to the serving cell when the UE is determined to be within the URLLC coverage area.

In an implementation of the first aspect, deactivating the coverage enhancement configuration comprises cancelling a repetition transmission over an allocated resource.

Another implementation of the first aspect further comprises receiving second data associated with enhanced mobile broadband (eMBB) traffic to be transmitted to the serving cell; determining that the UE is outside the URLLC coverage area; and activating the coverage enhancement configuration before transmitting the second data to the service cell.

Another implementation of the first aspect further comprises suspending a URLLC configuration used for transmission of the first data; and transmitting the second data to the serving cell using an eMBB configuration.

In another implementation of the first aspect, the eMBB configuration is associated with a first hybrid automatic repeat request (HARQ)-acknowledgement (ACK) codebook that is different from a second HARQ-ACK codebook associated with the URLLC configuration.

Another implementation of the first aspect further comprises releasing a URLLC configuration used for transmission of the first data; and transmitting the second data to the serving cell using an eMBB configuration.

In another implementation of the first aspect, transmitting the first data comprises transmitting the first data using a configured grant (CG) configuration associated with the URLLC traffic, the method further comprising transmitting the second data to the serving cell using the same CG configuration associated with the URLLC traffic and dropping the first data.

In another implementation of the first aspect, the URLLC coverage area is smaller than an eMBB coverage area when the coverage enhancement configuration is applied.

In another implementation of the first aspect, transmitting the first data comprises transmitting the first data using a URLLC configuration and transmitting the second data comprises transmitting the second data using an eMBB configuration, and both the URLLC configuration and the eMBB configuration are preconfigured to the UE by the serving cell.

In another implementation of the first aspect, determining whether the UE is within the URLLC coverage area comprises determining whether the UE is within the URLLC coverage area based on using at least one of Reference Signal (RS) Received Power (RSRP) measurements or configured RS.

In a second aspect of the present application, a UE configured with coverage enhancement configuration and comprising one or more non-transitory computer-readable media having computer-executable instructions; and at least one processor coupled to the one or more non-transitory computer-readable media is provided. The at least one processor is configured to execute the computer-executable instructions to receive first data associated with ultra reliable and low latency communications (URLLC) traffic to be transmitted to a serving cell; determine whether the UE is within a URLLC coverage area; and deactivate the coverage enhancement configuration before transmitting the first data to the serving cell when the UE determines that it is within the URLLC coverage area.

In a third aspect of the present application, a method for a base station is provided. The method includes: transmitting, to a user equipment (UE) configured with coverage enhancement configuration, a first configuration message to configure the UE for ultra-reliable and low-latency communications (URLLC) data transmission; transmitting, to the UE, a second configuration message to configure the UE for enhanced mobile broadband (eMBB) data transmission; and receiving, from the UE, an indicator indicating that the UE is within a URLLC coverage area, wherein the UE deactivates the coverage enhancement configuration while in the URLLC coverage area and uses the URLLC configuration to transmit data associated with URLLC traffic to the base station.

An implementation of the third aspect further comprises, after the UE moves out of the URLLC coverage area, receiving, from the UE, a second indicator indicating that the UE is outside the URLLC coverage area, wherein the UE: activates the coverage enhancement configuration while outside the URLLC coverage area, releases the URLLC configuration, and uses the eMBB configuration to transmit data associated with eMBB traffic to the base station.

### BRIEF DESCRIPTION OF THE DRAWINGS

Aspects of the exemplary disclosure are best understood from the following detailed description when read with the accompanying figures. Various features are not drawn to scale, and dimensions of various features may be arbitrarily increased or reduced for clarity of discussion.

FIG. 1 is a diagram illustrating different coverage areas for a UE configured with and without coverage enhancement configuration, according to an example implementation of the present application.

FIG. 2 is a flowchart illustrating a method (or process) performed by a UE to activate or deactivate coverage enhancement configuration depending on a location of the UE, according to an example implementation of the present application.

FIG. 3 is a flowchart illustrating a method (or process) performed by a base station to configure a UE with both URLLC and eMBB configuration such that the UE may switch between the two configurations depending on a location of the UE, according to an example implementation of the present application.

FIG. 4 illustrates a block diagram of a node for wireless communication, according to an example implementation of the present application.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C” or “at least one of the following: A, B and C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G NR Radio Access Network (RAN)) typically includes at least one base station, at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more base stations.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A base station may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A base station may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The base station may be operable to provide radio coverage to a specific geographical area using a plurality of cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmission). The BS may communicate with one or more UEs in the radio communication system through the plurality of cells.

A cell may allocate sidelink (SL) resources for supporting Proximity Service (ProSe) or Vehicle to Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services or V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship.

As discussed above, the next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, an MN may be formed by a Master Cell Group (MCG), and an SN may be formed by a Secondary Cell Group (SCG). In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise the term Special Cell may refer to the PCell. A Special Cell may support a Physical Uplink Control Channel (PUCCH) transmission and contention-based Random Access, and may always be activated. Additionally, for a UE in an RRC CONNECTED state that is not configured with the CA/DC, may communicate with only one serving cell (SCell) which may be the primary cell. Conversely, for a UE in the RRC CONNECTED state that is configured with the CA/DC a set of serving cells including the special cell(s) and all of the secondary cells may communicate with the UE.

As described above, the 5G NR uses high frequency radio bands for data communication. Using high frequency radio bands may result in shorter coverage area. To address this issue, 3GPP has introduced new mechanisms, such as the ones described below with reference to Table 1, for coverage enhancement in 5G NR to extend the coverage, for example, for Voice over Internet Protocol (VoIP) and/or Enhanced Mobile Broadband (eMBB) services. One or more of such mechanisms, however, may increase the latency which may become problematic when using other services, such as an Ultra Reliable and Low Latency Communication (URLLC) service, concurrently. The URLLC service has been introduced in 5G (e.g., by 3GPP) to support use cases with stringent requirements for extremely low latency (e.g., 1 ms) and high reliability (e.g., 99.999%). Examples of such services may include public safety, remote diagnosis/surgery, emergency response, autonomous driving, industrial automation, etc.

Some of the present implementations provide a mechanism for a UE that is configured with enhanced/extended coverage, such that the UE may be able to determine whether to use the coverage enhancement configuration or not depending on what service (e.g., URLLC service, eMBB/VoIP service, etc.) is used by the UE and/or the location of the UE. For example, a UE configured with coverage enhancement configuration that uses both the URLLC service and the eMBB/VoIP service to transmit UL data (e.g., URLLC traffic and eMBB traffic) to a serving cell, may be able to dynamically enable (or activate) or disable (or deactivate) the coverage enhancement configuration for such data transmission in some of the present implementations. In some implementations, a UE may initiate a protocol data unit (PDU) session for one type of traffic (e.g., to URLLC traffic to a serving cell), and initiate another PDU session associated with another type of traffic, such as eMBB traffic.

The UE of some such implementations may, depending on what PDU session is active (e.g., for data transmission) and in what coverage area the UE is located (e.g., within or outside a URLLC coverage area), enable or disable the configured coverage enhancement configuration. In other words, in some aspects of the present implementations, the UE may first, based on what application is transmitting the data (e.g., what PDU session is used for data transmission), determine whether to apply the coverage enhancement or not. After making such a determination, the UE may then apply different traffic configurations (e.g., URLLC configuration, eMBB configuration, etc.) to support only one of the services (e.g., URLLC, eMBB/VoIP) at a time, or to support two or more services (e.g., URLLC and eMBB, or URLLC and VoIP) simultaneously. For example, if the UE needs to use a URLLC service (e.g., to send URLLC traffic or packets to a serving cell), the UE may release its coverage enhancement configuration (e.g., disable repetition in time and/or frequency domains) and only use URLLC configuration to perform such URLLC service.

NR coverage enhancement has been introduced by 3GPP for target scenarios and services associated with different frequencies. For example, coverage enhancement may cover objectives, such as urban scenario, and rural scenario for Frequency Range 1 (FR1), Indoor scenario, and urban/suburban scenario or Frequency Range 2 (FR2), TDD and FDD for FR1, VoIP and eMBB service for FR1, eMBB service as first priority and VoIP as second priority for FR2, etc. The main potential solutions to improve coverage are illustrated below in Table 1.

TABLE 1

| | |
|---|---|
| Time domain | Enhanced repetition, e.g., increased number of repetitions |
| | Msg3 repetition |
| | Enhanced repetition mechanism to overcome frequent |
| | cancellation of the repetition due to DL/UL collision for |
| | TDD |
| | Early termination of PUSCH repetition |
| | Finer retransmission, e.g., More RVs |
| Frequency domain | Enhanced frequency hopping, e.g. inter/intra-slot hopping |
| | with more frequency positions |
| | Frequency selective diversity, e.g., comb-like |
| | Intra-PUSCH hopping, e.g., finer granularity in time |
| | domain for one PUSCH |
| | Sub-PRB transmission, e.g., half PRB |
| Spatial domain | Transmit diversity |
| | UL beam management |
| | Multiple-panel beam management |
| Code domain | Spreading w/ CDM, e.g., PUCCH-like PUSCH |
| Power domain | Enhancement of power control |
| | Higher power UE for FDD |
| | PSD boosting |
| Packet aggregation | Aggregate multiple RTP packets into one RTP packet |
| DM-RS enhancement | Multi/cross-slot channel estimation |
| | Overhead reduction, e.g., DM-RS less slot |
| | Increased DMRS density |

Some or all of the above-mentioned approaches may improve VoIP and eMBB service coverage, for example, for FR1. However, some or all of these approaches may not be applicable to URLLC service coverage. As an example, the time domain repetition mechanism may extend the coverage for the VoIP and/or eMBB services, but may, at the same time, increase the latency, hence not applicable to the URLLC service. As such, URLLC services which require low latency may not use enhancement in coverage which may result in shorter service coverage (e.g., compared to VoIP/eMBB services from the perspective of the same UE).

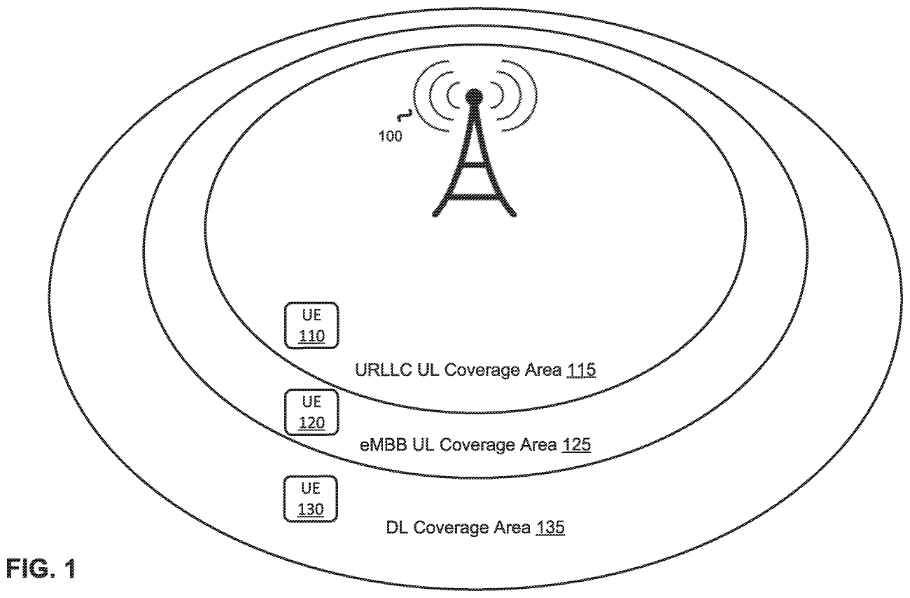

FIG. 1 is a diagram illustrating different coverage areas for a UE configured with and without coverage enhancement configuration, according to an example implementation of the present application. FIG. 1 includes a base station 100 (e.g., a gNB or an eNB) having three different service coverage areas and a UE in each coverage area. More specifically, UE 110 is located within coverage area 115, UE 120 is located within coverage area 125, and UE 130 is located within coverage area 135. In the illustrated example, UE 110 is not configured with enhanced coverage configuration for uplink (UL) transmission, while UE 120 is configured with such configuration for UL transmission. As such, UL coverage area 125 (e.g., within which UE 120 may transmit data, such as eMBB traffic, to BS 100) is larger than UL coverage area 115 (e.g., within which UE 110 may transmit data, such as URLLC traffic, to BS 100). Additionally, UE 130 is within DL coverage (or transmission) area 135 which is generally larger than uplink coverage (or transmission) areas 115 and 125, since DL transmissions are enabled by BS 100's transmission power (e.g., as opposed to UL transmissions which are enabled by the UEs' transmission power).

It should be noted that even though eMBB is mostly used to describe services that may require coverage enhancement configuration, other services, such as VoIP, etc., are equally applicable to the above and below descriptions.

The URLLC coverage area 115 may support both eMBB and URLLC traffic. That is, UE 110 may transmit UL data associated with URLLC traffic and eMBB traffic without requiring to be configured with coverage enhancement. On the other hand, in the area between coverage area 115 and coverage area 125, UE 120 may be able to transmit UL traffic to BS 100 only if UE 120 is configured with coverage enhancement configuration. As such, if UE 120 receives a signal to transmit URLLC packet(s) to BS 100, while the UE is configured with coverage enhancement configuration, the UE may ignore such a request, for example, because the UE may have released its URLLC configuration after determining that the UE is out of the URLLC coverage area 115. Using different traffic configurations for transmitting different types of traffic to a serving cell is described in more detail below.

Hybrid Automatic Repeat Request (HARQ) is a functionality that may ensure the delivery (e.g., of data) between peer entities, for example, at Layer 1 (i.e., Physical Layer). A single HARQ process may support one Transport Block (TB) when the physical layer is not configured for DL/UL spatial multiplexing. When the physical layer is configured for DL/UL spatial multiplexing, a single HARQ process may support one or multiple TBs. There may be one HARQ entity associated with a serving cell. Each HARQ entity may support a parallel (number) of DL and UL HARQ processes. A HARQ acknowledgement (HARQ-ACK) may include acknowledgement information, such as a bit value of 0 that represents a negative acknowledgement (NACK) and a bit value of 1 that represents a positive acknowledgement (ACK).

In some implementations, at least two HARQ-ACK codebooks with their respective configurations may be simultaneously constructed for supporting different service types for a UE. In some aspects of the present implementations, while the UE is in eMBB UL coverage area 120, but outside URLLC UL coverage area 115 (e.g., where UE 120 is located), with regards to the URLLC configuration (e.g., sub-slot-based configuration), the UE may suspend the URLLC configuration and apply HARQ-ACK codebook associated with, for example eMBB only. The URLLC configuration may be activated only when the UE is in URLLC coverage area 115.

It should be noted that the service cell (e.g., associated with BS 100) may configure the corresponding URLLC configuration while the UE is within coverage area 115 or coverage area 125. That is, the UE applying the coverage enhancement or not may be transparent to the UE. In some aspects of the present implementations, the UE may notify the serving cell about the coverage enhancement being activated, and then the UE may treat the corresponding URLLC configuration, for example, received outside the URLLC coverage area 115, as an error case.

In some other aspects of the present implementations, with regards to the URLLC configuration (e.g., sub-slot-based configuration), the UE may release the corresponding URLLC configuration when the UE moves out of the URLLC coverage area 115. In some implementations, the UE may also activate the eMBB/VoIP coverage enhancement configuration when moving out of the URLLC coverage area 115. In some implementations, the UE may reply negative acknowledgment (NACK) when receiving the corresponding URLLC configuration (e.g., when the UE is outside URLLC coverage area 115). The corresponding URLLC configuration may include PUSCH repetition type (e.g., pusch-RepTypeB), UCI-OnPUSCH, PUSCH-TimeDomainResourceAllocationList, CI-PayloadSize, timedurationforCl, frequencyHopping-PUSCHRepTypeB, etc. (e.g., mainly for Type B transmissions based on PUSCH and CI mechanisms).

It should be noted that suspending the URLLC configuration and applying the HARQ-ACK codebook associated with, for example eMBB only, may be more efficient when a UE is moving in and out of the URLLC coverage area 115 (e.g., UE 110 moves to where UE 120 is located and then moves back to coverage area 115 in a short amount of time). On the other hand, releasing the corresponding URLLC configuration may be more efficient when a UE moves out of the coverage area 115 and stays out of this area for a long period of time.

In some implementations, a dynamic indication of the number of repetitions for dynamic grant that jointly coded with Start and Length Indicator (SLIV) for time domain RA (TDRA) table may be used. In addition, the time window within which valid symbols are used for transmission may be interpreted as L*K (L and K being non-negative integers), starting from the first symbol indicated by the SLIV in TDRA field for the PUSCH with enhanced repetition transmission. In some implementations, the indication and interpretation may be applicable only when the UE is within URLLC coverage area 115, otherwise, the UE may interpret the respective values of L and K based on legacy 5G (e.g., as described in 3GPP Release Rel-15) outside coverage area 115. In some implementations, the NW may or may not know whether Coverage Enhancement (CE) is activated. In some implementations, the UE may determine an error case if the NW knows that the UE is outside URLLC coverage area 115, but signals indicators corresponding to URLLC coverage area. In some implementations, the UE may either ignore the granted resources or re-interpret the indicator used for outside URLLC coverage area automatically, or may transmit a specific indicator (e.g., a NACK and/or a coverage change indicator) to let the NW know that the UE is not within URLLC coverage area 115.

In some implementations, a UE may receive a DL Control Information (DCI) scheduling a PUSCH transmission on a UL bandwidth part (BWP). A BWP is a subset of the total cell bandwidth of a cell. The Bandwidth Adaptation (BA) is achieved by configuring the UE with BWP(s) and telling the UE which of the configured BWPs is currently the active one. To enable BA on the PCell, the gNB may configure the UE with UL and DL BWP(s). To enable BA on the SCells in case of CA, the gNB may configure the UE with at least DL BWP(s) (e.g., there may be none in the UL). For the PCell, the initial BWP is the BWP used for initial access. For the SCell(s), the initial BWP may be the BWP that is configured for the UE to first operate at the SCell's activation. The UE may be configured with a first active UL BWP by a firstActiveUplinkBWP information element (IE). If the first active UL BWP is configured for an SpCell, the firstActiveUplinkBWP IE field may contain the ID of the UL BWP to be activated upon performing the RRC (re)configuration. If this field is absent, the RRC (re)configuration may not impose a BWP switch. If the first active UL BWP is configured for an SCell, the firstActiveUplinkBWP IE field may contain the ID of the UL bandwidth part to be used upon MAC-activation of an SCell.

In some implementations, the format of the DCI that schedules the PUSCH transmission (e.g., on a UL BWP) may have been preconfigured by the base station (e.g., a gNB) as an implicit indication, which may indicate that the UE should perform type B PUSCH repetition for the PUSCH transmission corresponding to the format of the DCI. In such a case, the UE may perform type A PUSCH repetition for the PUSCH transmission scheduled by the DCI if the UE is not in URLLC coverage area 115. Furthermore, the UE may repeat the PUSCH transmissions for a number of times based on the configuration that is, for example, preconfigured for the UL BWP of the PUSCH. That is, the UE may ignore the number of repetitions preconfigured within a specific RRC configuration (e.g., specific to the format of the DCI) and further indicated, for example, through the Time domain resource assignment field of the format of the DCI. The UE may apply the number of repetitions indicated by the pusch-AggregationFactor of the UL BWP or the serving cell of the UL BWP.

In some other implementations, a UE may receive a DCI scheduling a PUSCH transmission on a UL BWP. In some such implementations, the format of the DCI may have been preconfigured (e.g., by a gNB) as an implicit indication which may indicate that the UE should perform type B PUSCH repetition for the PUSCH transmission corresponding to the format of the DCI. In such a case, the UE may still perform type B PUSCH repetition for the PUSCH transmission scheduled by the DCI if the UE is not in URLLC coverage area 115. Additionally, the UE may repeat the PUSCH transmissions for a number of times based on the configuration that is, for example, preconfigured for the UL BWP of the PUSCH. That is, the UE may ignore the number of repetitions preconfigured within a specific RRC configuration (e.g., specific to the format of the DCI) and further indicated by the Time domain resource assignment field of the format of the DCI. The UE may apply the number of repetitions indicated by the pusch-AggregationFactor of the UL BWP or the serving cell of the UL BWP.

In some other implementations, a UE may receive a DCI scheduling a PUSCH transmission on a UL BWP. In some such implementations, the format of the DCI may have been preconfigured by the gNB as an implicit indication which may indicate that the UE may still perform type A PUSCH repetition for the PUSCH transmission corresponding to the format of the DCI. That is, the UE may still perform type A PUSCH repetition for the PUSCH transmission scheduled by the DCI if the UE is outside URLLC coverage area 115. Furthermore, the UE may repeat the PUSCH transmissions for a number of times defined by the configuration that is, for example, preconfigured for the UL BWP of the PUSCH. That is, the UE may ignore the number of repetitions preconfigured within a specific RRC configuration (e.g., specific to the format of the DCI) and further indicated by the Time domain resource assignment field of the format of the DCI. The UE may apply the number of repetition indicated by the pusch-AggregationFactor of the UL BWP or the serving cell of the UL BWP.

Some of the present implementations may provide a new Radio Network Temporary Identifier (RNTI), as a cancelation indicator. For example, a Cancelation Indication-RNTI (CI-RNTI) may be used and the SRS/PUSCH may be canceled by the UL CI. Moreover, the time and frequency resources for cancelation may be jointly indicated/configured by a 2D-bitmap (e.g., similar to the DL PI) over the time and frequency partitions within the reference region. In of the present implementations, each UL cancelation indicator per serving cell may have an RRC configurable field size of X bits (X being a positive number) which traditionally supports per serving cell configuration for the parameters of CI-PayloadSize, timedurationforCl, timeGranularityforCI, frequencyRegionforCI.

Some of the present implementations may continue monitoring the CI-RNTI, for example, based on a configured monitoring pattern. A UE (e.g., that supports eMBB services), however, may skip the CI-RNTI while the UE is outside URLLC coverage area 115 (e.g., assuming that all a UE that supports URLLC services could be reached within the URLLC coverage area). It should be noted that skipping the CI-RNTI, as described before, may refer to UE that may only skip the monitoring of the occasion and/or search space that are associated with the CI-RNTI. In some implementations, other configured RNTI monitoring may be continued. More specifically, the UE may skip monitoring the occasion and/or search space of the UL CI (and/or CI-RNTI) while the UE (that supports eMBB services) is outside URLLC coverage area 115, even if the UE is within DRX active time.

The above-described specific CI-RNTI skipping may be applied together with Wake Up Signaling (WUS). For example, if WUS is configured and indicated to the UE to skip the entire PDCCH monitoring, skipping the CI-RNTI may be applied regardless of the UE being within or outside URLLC coverage area 115. In some of the present implementations, if WUS is configured, but indicated to the UE not to skip the entire PDCCH monitoring, the UE may further determine whether to skip the CI-RNTI or not based on the UE's location. For example, whether to skip the CI-RNTI may be configurable to the UE, for example, when the NW may assign higher priority to the coverage enhancement feature rather than to the URLLC feature. Conversely, the NW may keep higher priority for URLLC services (e.g., rather than eMBB services). In some implementations, skipping the CI-RNTI may be based on a default value, for example, corresponding to a default behavior, when the NW does not configure the skipping of the CI-RNTI monitoring. One example may be when the NW knows whether coverage enhancement is used, and consequently the NW may not provide the configuration and a default behavior may be used for the skipping.

Some other implementations may suspend the monitoring of CI-RNTI while the UE is outside URLLC coverage area 115 and a non-cancelation procedure may be performed accordingly. In some such implementations, the UE may resume the monitoring of CI-RNTI when it (re)enters the URLLC coverage area 115.

In some such implementations, an additional indicator may be signaled (e.g., by the serving cell) to the UE to configure the UE for suspending the monitoring of CI-RNTI. In some implementations, such an indicator may be signaled to the UE when the serving cell may have knowledge of, or control and/or configure, the eMBB/VoIP coverage enhancement on the UE. The additional indicator may be transmitted via an RRC message, a DCI, or a MAC control element (CE).

In addition to the cancelation mechanisms described above, some of the present implementations may provide a power control mechanism to handle the inter-UE prioritization. For example, one bit (e.g., separate from the SRI) in the UL grant may be used to indicate an open loop power control parameter set. The one-bit indicator may be presented in the UL grant when the above-described RRC parameter is configured and if this bit is present, it may be used to switch between the P0 value from the existing P0-PUSCH-AlphaSet and the P0 value from the newly configured P0-PUSCH-Set. In some implementations this one bit indicator may be expanded to 2 or more bits which may be configured, for example in advance, by an RRC parameter that contains multiple P0-PUSCH-Set per SRI. As an example, one bit may be used for URLLC coverage area 115, while a URLLC service is running, a second bit may be used for eMBB coverage area 125, while an eMBB service is running, and a third bit may be used for any location outside URLLC coverage area 115. In some such implementations, the UE may be indicated to apply corresponding power control parameters, for example, set by decoding the multi-bit indicator/parameter.

In NR, each configure grant (CG) configuration may be configured independently, while simultaneous Type 1 and Type 2 CG configurations over a BWP may also be supported. More specifically, a HARQ offset parameter (e.g., HARQ-ProcID-offset) may be explicitly configured (e.g., by the network) for each CG/SPS configuration with regards to the used HARQ process ID. In NR, a base station (or a serving cell) may allocate UL resources for the initial HARQ transmissions to the UEs. Two types of CGs are defined in NR. Type 1 CG, in which the network, for example through RRC signaling, may directly provide the configured UL grant (including the periodicity), and Type 2 CG, in which the network, for example through RRC signaling, may define the periodicity of the configured UL grant while PDCCH addressed to CS-RNTI may either signal and activate the configured UL grant, or deactivate it. That is, a PDCCH addressed to the CS-RNTI may indicate that the UL grant may be implicitly reused according to the periodicity defined by RRC, until deactivated.

When a configured UL grant is active, if the UE cannot find its C-RNTI/CS-RNTI/MCS-C-RNTI on the PDCCH(s), an UL transmission according to the configured UL grant can be made. Otherwise, if the UE finds its C-RNTI/CS-RNTI/MCS-C-RNTI on the PDCCH(s), the PDCCH allocation overrides the configured UL grant. It is noted that, the usage of MCS-C-RNTI is equivalent to that of C-RNTI in MAC procedures (except for the C-RNTI MAC CE).

While coverage enhancement is applied, uplink CG resources may become invalid for a UE (e.g., when the UE is outside URLLC coverage area 115) even though buffered URLLC packets may still exist. In such a situation, in some aspects of the present implementations, a common CG configuration may be used for both within and outside URLLC coverage area 115. In one aspect of the present implementations, the UE may suspend the CG configuration and further send a signaling to the serving cell to indicate the corresponding CG resources that may be released. In another aspect of the present implementations, the UE may release the CG configuration and do nothing while the UE is outside URLLC coverage area 115 with regards to the CG operation. In yet another aspect of the present implementations, the UE may continue applying the CG configuration, but may relax the restriction on eMBB services that are transmitted via the CG resources.

In some other aspects of the present implementations, a separate CG configuration may be used for each of URLLC coverage area 115 and eMBB coverage area 125. In one aspect of the present implementations, the UE may automatically switch the CG configuration depending on its location (e.g., being within or outside URLLC coverage area 115). In some implementations, the CG configuration for the outside URLLC coverage area 115 locations may have longer periodicity (e.g., according to the NW implementation). The CG configuration may refer to Type 1 and or Type 2 CG. Regarding Type 2 CG, the switching, as described above, may only be used while the DCI has already activated the CG resources. Otherwise, the switching may be prohibited (e.g., since the CG resources are not activated) if the DCI doesn't activate the configuration. More specifically, the UE switching the CG may be in response to the UE deactivating/releasing/clearing the original CG and applying/activating/initializing the new CG.

In one aspect of the present implementations, the separate CG configuration may have or may not have partially overlapped resource allocation and the cell may use explicit signaling to configure the associating parameter set. In another aspect of the present implementations, the separate CG configuration may be applied by implicit signaling. For example, a scaling factor (e.g., either a predefined or default factor) may be used to calculate the new CG occasion/allocation when the UE moves out of URLLC coverage area 115.

For retransmission of the PUSCH scheduled by a new UL DCI format with CRC scrambled by CS-RNTI (e.g., with NDI=1), in some of the present implementations, the UE may follow the same higher layer configuration, for example, defined for dynamic PUSCH transmission associated with the new UL DCI format (e.g., except for p0-NominalWithoutGrant, p0-PUSCH-Alpha, powerControlLoopToUse, path lossReferenceIndex parameters). On the other hand, while the UE is outside URLLC coverage area 115, the UE may follow the same configuration regardless of the UE's location (e.g., within or outside URLLC coverage area 115), or the UE may follow a new coverage enhancement-specific configuration configured by the higher layer, or alternatively, the UE may follow the same configuration with the traditional UL DCI format (e.g., scrambled by the C-RNTI).

Regarding Redundancy Version (RV), 3GPP has also introduced the RRC signaling per CG configuration to enable/disable the feature of starting from any RV0 occasion for RV cyclic sequences {0, 0, 0, 0} and {0, 3, 0, 3}. While coverage enhancement is applied, the UE may act differently in different implementations. In some aspects of the present implementations, instead of an enabling/disabling mechanism, the RRC signaling per CG configuration may indicate the index of the feature of starting from RV0 occasion for RV cyclic sequences. In some such implementations, each different index may map to a different sequence and the UE may perform a retransmission according to the sequence. For instance, a UE that supports eMBB services may use a specific index for locations outside URLLC coverage area 115, while a UE that supports URLLC services may use another specific index for locations outside URLLC coverage area 115.

In some other aspects of the present implementations, the enabling/disabling mechanism may still be valid only when the UE is within URLLC coverage area 115. The UE may apply a unified sequence while moving out of URLLC coverage area 115. In some such implementations, the RRC signaling per CG configuration of the RV version may be suspended. In yet other aspects of the present implementations, the UE may always apply a disable status while the UE is outside URLLC coverage area 115.

In some of the present implementations, when a UE determines that it is not within a URLLC coverage area, such as coverage area 115, the UE may perform one or more actions including flushing the HARQ buffers, releasing the PUCCH resources and the SRS (e.g., all configured within URLLC coverage area), clearing any configured downlink assignments and configured uplink grants (e.g., configured within URLLC coverage area), and clearing any PUSCH resource for semi-persistent CSI reporting (e.g., configured within URLLC coverage area).

In order to determine the coverage area (being located with a URLLC coverage area or an eMBB coverage area), a UE of some of the present implementations may perform one or more methods of location determinations. For example, the UE may determine the coverage area by comparing a measured RSRP against an RSRP threshold(s), for example, configured by a gNB. For example, if the measured RSRP is higher than the configured RSRP threshold, the UE may determine that it is within URLLC coverage area 115. Otherwise, the UE may determine that it is outside URLLC coverage area (e.g., and within an eMBB coverage area). Additionally, a UE may determine its location based on a selected and/or configured RS. For example, a coverage area may be associated with a particular set of reference signals. For example, when the UE selects a SSB with an specific SSB index when performing an initial access, the UE may determine that it is within a coverage associated with a particular RS. As another example, a UE may determine the coverage area based on the referenceSignal parameter of the activated PUCCH Spatial Relation Info in some of the present implementations.

Additionally, based on the coverage area determination, a UE may determine its current coverage area while the UE moves about. For example, if a UE changes its coverage area (e.g., the UE moves outside a URLLC coverage area and into an eMBB coverage area), based on the coverage area determination (e.g., when a measurement RSRP result is lower than a threshold), the UE may trigger a procedure and/or send an indication to the NW to indicate to the NW that the UE has changed its coverage area or the status of the coverage. In some aspects of the present implementations, the triggered procedure (and/or the indication) may include a specific RRC/MAC/PHY layer signaling procedure, a measurement report procedure, or an RA procedure. For example, the UE may select a specific preamble which may implicitly indicate the information corresponding to a coverage area change.

In some aspects of the present implementations, the indication may include a measurement result (e.g., for SSB/CSI-RS), while in other aspects, the indication may include data (e.g., index) associated with the coverage area (e.g., as described above). In yet some other aspects of the present implementations, the indication may include a specific UE assistance information.

In some aspects of the present implementations, the indication may be transmitted using the configuration associated with the coverage area in which the UE is currently located. For example, if the UE moves out of a URLLC coverage area, the UE may transmit an indicator to the serving cell using the configuration that is associated with eMBB coverage area, or a different coverage area. The associated configuration may include, but is not limited to, PUCCH-ConfigCommon-non-uULC (meaning outside URLLC coverage area), PUSCH-ConfigCommon-non-uULC, RACH-ConfigCommon-non-uULC (e.g., which may further include the number of repetitions for PRACH transmission in non-uULC), RACH-ConfigGeneric-non-uULC, DCI formats and corresponding TDRA tables for non-uULC (e.g., for message exchange with gNB following the indication), etc.

In some implementations, the UE may treat coverage area indication as an eMBB services and apply eMBB-specific configuration to transmit it to the serving cell. In some implementations, the indication may have higher priority than normal eMBB PDU (e.g., when a MAC CE signaling is used).

It should be noted that the measurement described above for coverage area determination may include a Layer-3 measurement. That is, in some implementations, the measurement results may reflect the UE's mobility with some delays (e.g., since the samples need to be averaged in time).

It should also be noted that part of the control mechanisms described above are described based on DCI. DCI control mechanisms resolve the described delays since fast responses are needed. In addition to Layer-3 measurements, part or all of the signaling exchange may also include MAC CE and/or RRC signaling.

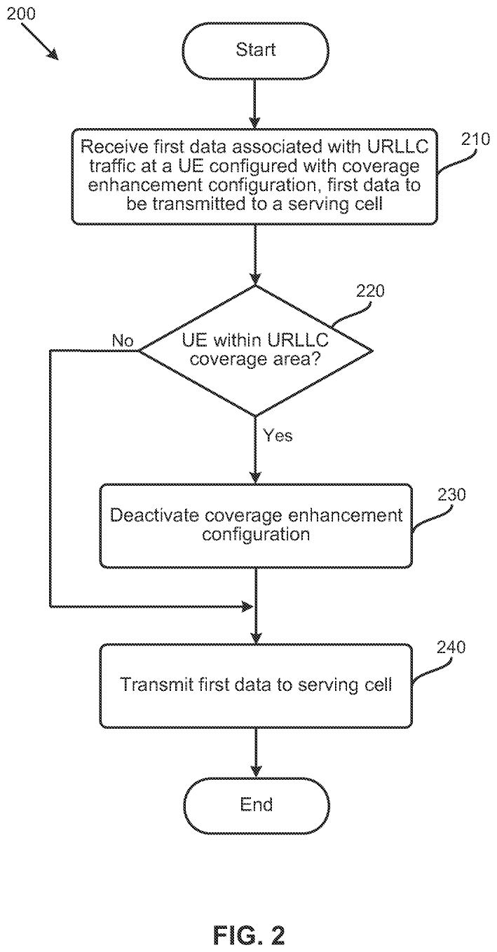

FIG. 2 is a flowchart illustrating a method (or process) 200 performed by a UE to activate or deactivate coverage enhancement configuration depending on a location of the UE, according to an example implementation of the present application.

As shown in the figure, process 200 may start by a UE that is configured with coverage enhancement configuration receiving, at 210, first data associated with ultra-reliable and low-latency communications (URLLC) traffic that is to be transmitted to a serving cell (e.g., associated with a gNB). As described above, this data may be received after a PDU session for UL transmission of a particular type of traffic (e.g., URLLC traffic, eMBB traffic, VoIP traffic, etc.) has been initiated at the UE (e.g., by an application executing on the UE that needs to transmit UL data to the network). As such, the first data may include one or more URLLC packets, eMBB packets, or other types of traffic packets.

At 220, process 200 may determine whether the UE is within a URLLC coverage area, such as URLLC coverage area 115 with reference to FIG. 1, or not. As described above, process 200 may determine the coverage area by comparing a measured RSRP against an RSRP threshold(s), for example, configured by a base station. For example, if the measured RSRP is higher than the configured RSRP threshold, the process may determine that the UE is within a URLLC coverage area. Otherwise, process 200 may determine that the UE is outside the URLLC coverage area (e.g., and within an eMBB coverage area).

If process 200 determines that the UE is within the URLLC coverage area (e.g., based on the mechanism(s) described above), the process may deactivate, at 230, the coverage enhancement configuration. However, if the process determines that the UE is outside the URLLC coverage area (e.g., in an eMBB or VoIP coverage area, such as coverage area 125), the process may keep the coverage enhancement configuration activated/enabled. In some implementations, process 200 may enable or activate the coverage enhancement configuration on the UE if this configuration has been deactivated/disabled previously when the process determines that the UE is outside the URLLC coverage area.

Process 200 may then transmit, at 240, the first data to the serving cell. For example, if process 200 determines that the UE is within a URLLC coverage area and the first data is associated with URLLC traffic, the process may deactivate/disable the coverage enhancement configuration on the UE and then transmit the UL traffic to the serving cell. On the other hand, if process 200 determines that the UE is outside the URLLC coverage area and the first data is associated with eMBB traffic, the process may keep the coverage enhancement configuration on the UE activated/enabled and then transmit the UL traffic to the serving cell. The process may then end.

As described above, deactivating the coverage enhancement configuration on the UE may include cancelling a repetition transmission over an allocated resource to the serving cell. In some implementations when the process determines that the UE is outside a URLLC coverage area, but inside an eMBB coverage area and the UL traffic is eMBB traffic, the process may suspend (or release) a URLLC configuration used for transmission of the URLLC traffic and transmit the eMBB traffic to the serving cell using an eMBB configuration. As described above, the eMBB configuration may be associated with a first hybrid automatic repeat request (HARQ)-acknowledgement (ACK) codebook that is different from a second HARQ-ACK codebook associated with the URLLC configuration.

In some implementations, the process may transmit the URLLC traffic to the serving cell (e.g., while the UE is within a URLLC coverage area) using a configured grant (CG) configuration associated with the URLLC traffic. In some such implementations, if the process determines that the UE has moved out of the URLLC coverage area and now has UL eMBB traffic to be transmitted to the serving cell, the process may transmit the eMBB traffic to the serving cell using the same CG configuration associated with the URLLC traffic (e.g., while dropping the URLLC data.

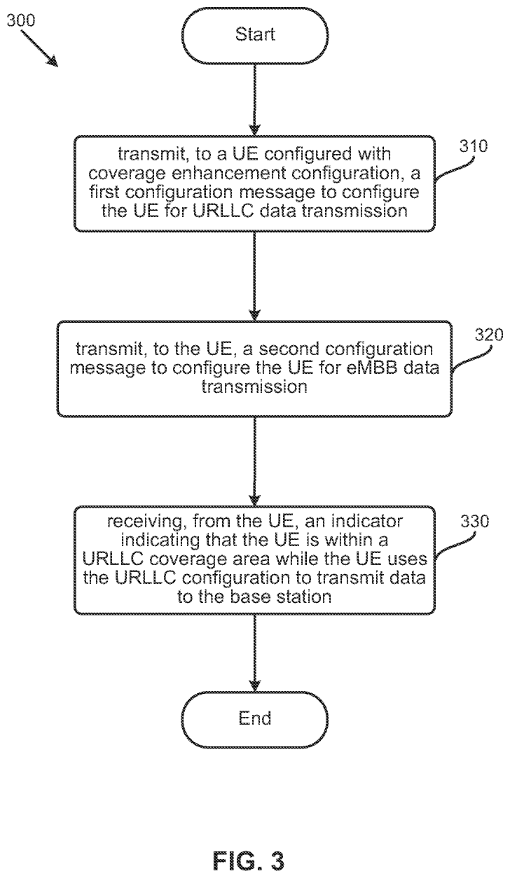

FIG. 3 is a flowchart illustrating a method (or process) 300 performed by a base station to configure a UE with both URLLC and eMBB configuration such that the UE may switch between the two configurations depending on a location of the UE, according to an example implementation of the present application.

As shown in the figure, process 300 may transmit, at 310, to a UE configured with coverage enhancement configuration, a first configuration message to configure the UE for ultra reliable and low latency communications (URLLC) data transmission. Process 300 may also transmit, at 320, to the UE, a second configuration message to configure the UE for enhanced mobile broadband (eMBB) data transmission.

At 330, process 300 may receive, from the UE, an indicator indicating that the UE is within a URLLC coverage area, after or concurrently with the UE deactivating the coverage enhancement configuration while in the URLLC coverage area and using the URLLC configuration to transmit data associated with URLLC traffic to the base station. In some implementations, the indicator sent by the UE to the BS (e.g., when the UE moves out of the URLLC coverage area) is for indicating to the BS that the location is changed and as such, the BS may react to such change of location accordingly (e.g., the BS may forgo scheduling URLLC resources on the UE). The process may then end.

In some implementations, after the UE moves out of the URLLC coverage area, process 300 may receive, from the UE, a second indicator that indicates to the BS that the UE is outside the URLLC coverage area. After (or concurrently with) receiving this indicator, the process may (re)activate the coverage enhancement configuration on the UE (e.g., while the UE is outside the URLLC coverage area), release the URLLC configuration, and use the eMBB configuration to transmit data associated with eMBB traffic to the base station.

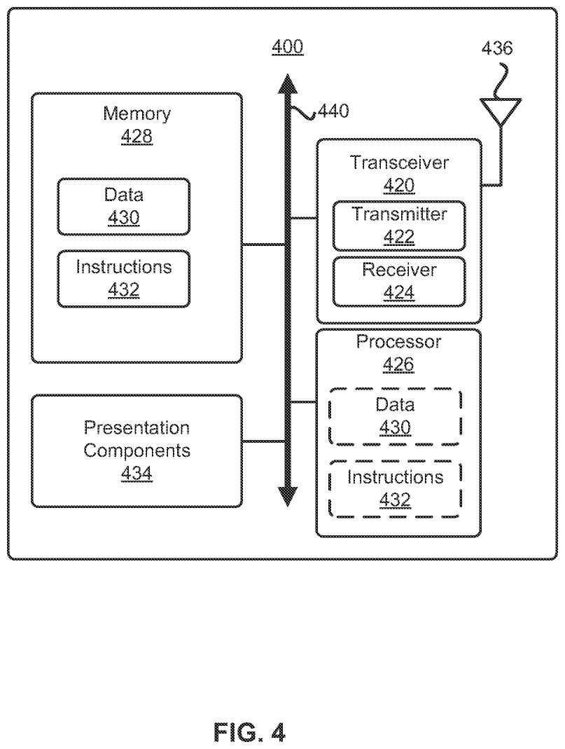

FIG. 4 illustrates a block diagram of a node for wireless communication, according to one example implementation of the present application. As shown in FIG. 4, node 400 may include transceiver 420, processor 426, memory 428, one or more presentation components 434, and at least one antenna 436. Node 400 may also include a Radio Frequency (RF) spectrum band module, a base station communications module, a network communications module, and a system communications management module, input/output (I/O) ports, I/O components, and power supply (not explicitly shown in FIG. 4). Each of these components may be in communication with each other, directly or indirectly, over one or more buses 440.

Transceiver 420 having transmitter 422 and receiver 424 may be configured to transmit and/or receive time and/or frequency resource partitioning information. In some implementations, transceiver 420 may be configured to transmit in different types of subframes and slots including, but not limited to, usable, non-usable and flexibly usable subframes and slot formats. Transceiver 420 may be configured to receive data and control signaling.

Node 400 may include a variety of computer-readable media. Computer-readable media can be any available media that can be accessed by node 400 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 428 may include computer-storage media in the form of volatile and/or non-volatile memory. Memory 428 may be removable, non-removable, or a combination thereof. Exemplary memory includes solid-state memory, hard drives, optical-disc drives, and etc. As illustrated in FIG. 4, memory 428 may store computer-readable, computer-executable instructions 432 (e.g., software codes) that are configured to, when executed, cause processor 426 to perform various functions described herein, for example, with reference to FIGS. 1 through 4. Alternatively, instructions 432 may not be directly executable by processor 426 but be configured to cause node 400 (e.g., when compiled and executed) to perform various functions described herein.

Processor 426 may include an intelligent hardware device, for example, a central processing unit (CPU), a microcontroller, an ASIC, and etc. Processor 426 may include memory. Processor 426 may process data 430 and instructions 432 received from memory 428, and information through transceiver 420, the base band communications module, and/or the network communications module. Processor 426 may also process information to be sent to transceiver 420 for transmission through antenna 436, to the network communications module for transmission to a core network.

One or more presentation components 434 presents data indications to a person or other device. For example, one or more presentation components 434 include a display device, speaker, printing component, vibrating component, etc.

From the above description it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for a user equipment (UE) configured with coverage enhancement configuration, the method comprising:
receiving first data associated with ultra reliable and low latency communications (URLLC) traffic to be transmitted to a serving cell;
determining whether the UE is within a URLLC coverage area; and
deactivating the coverage enhancement configuration before transmitting the first data to the serving cell when the UE is determined to be within the URLLC coverage area.

2. The method of claim 1, wherein deactivating the coverage enhancement configuration comprises cancelling a repetition transmission over an allocated resource.

3. The method of claim 1, further comprising:
receiving second data associated with enhanced mobile broadband (eMBB) traffic to be transmitted to the serving cell;
determining that the UE is outside the URLLC coverage area; and
activating the coverage enhancement configuration before transmitting the second data to the service cell.

4. The method of claim 3, further comprising:
suspending a URLLC configuration used for transmission of the first data; and
transmitting the second data to the serving cell using an eMBB configuration.

5. The method of claim 4, wherein the eMBB configuration is associated with a first hybrid automatic repeat request (HARQ)-acknowledgement (ACK) codebook that is different from a second HARQ-ACK codebook associated with the URLLC configuration.

6. The method of claim 3, further comprising:
releasing a URLLC configuration used for transmission of the first data; and
transmitting the second data to the serving cell using an eMBB configuration.

7. The method of claim 3, wherein transmitting the first data comprises transmitting the first data using a configured grant (CG) configuration associated with the URLLC traffic, the method further comprising:
transmitting the second data to the serving cell using the same CG configuration associated with the URLLC traffic and dropping the first data.

8. The method of claim 3, wherein the URLLC coverage area is smaller than an eMBB coverage area when the coverage enhancement configuration is applied.

9. The method of claim 3, wherein:
transmitting the first data comprises transmitting the first data using a URLLC configuration and transmitting the second data comprises transmitting the second data using an eMBB configuration, and
both the URLLC configuration and the eMBB configuration are preconfigured to the UE by the serving cell.

10. The method of claim 1, wherein determining whether the UE is within the URLLC coverage area comprises determining whether the UE is within the URLLC coverage area based on using at least one of Reference Signal (RS) Received Power (RSRP) measurements or configured RS.

11. A user equipment (UE) configured with coverage enhancement configuration, comprising:
one or more non-transitory computer-readable media storing computer-executable instructions; and
at least one processor coupled to the one or more non-transitory computer-readable media, and configured to execute the computer-executable instructions to:
receive first data associated with ultra reliable and low latency communications (URLLC) traffic to be transmitted to a serving cell;
determine whether the UE is within a URLLC coverage area; and
deactivate the coverage enhancement configuration before transmitting the first data to the serving cell when the UE is determined to be within the URLLC coverage area.

12. The method of claim 10, wherein deactivating the coverage enhancement configuration comprises cancelling a repetition transmission over an allocated resource.

13. The method of claim 10, wherein the at least one processor is further configured to execute the computer-executable instructions to:
receive second data associated with enhanced mobile broadband (eMBB) traffic to be transmitted to the serving cell;
determine that the UE is outside the URLLC coverage area; and
activate the coverage enhancement configuration before transmitting the second data to the service cell.

14. The method of claim 13, wherein the at least one processor is further configured to execute the computer-executable instructions to:
suspend a URLLC configuration used for transmission of the first data; and
transmit the second data to the serving cell using an eMBB configuration.

15. The method of claim 14, wherein the eMBB configuration is associated with a first hybrid automatic repeat request (HARQ)-acknowledgement (ACK) codebook that is different from a second HARQ-ACK codebook associated with the URLLC configuration.

16. The method of claim 13, wherein the at least one processor is further configured to execute the computer-executable instructions to:
release a URLLC configuration used for transmission of the first data; and
transmit the second data to the serving cell using an eMBB configuration.

17. The method of claim 13, wherein transmitting the first data comprises transmitting the first data using a configured grant (CG) configuration associated with the URLLC traffic, wherein the at least one processor is further configured to execute the computer-executable instructions to:
transmit the second data to the serving cell using the same CG configuration associated with the URLLC traffic and dropping the first data.

18. The method of claim 13, wherein the URLLC coverage area is smaller than an eMBB coverage area when the coverage enhancement configuration is applied.

19. The method of claim 13, wherein:
transmitting the first data comprises transmitting the first data using a URLLC configuration and transmitting the second data comprises transmitting the second data using an eMBB configuration, and
both the URLLC configuration and the eMBB configuration are preconfigured to the UE by the serving cell.

20. A method for a base station, comprising:
transmitting, to a user equipment (UE) configured with coverage enhancement configuration, a first configuration message to configure the UE for ultra reliable and low latency communications (URLLC) data transmission;
transmitting, to the UE, a second configuration message to configure the UE for enhanced mobile broadband (eMBB) data transmission; and
receiving, from the UE, an indicator indicating that the UE is within a URLLC coverage area, wherein the UE deactivates the coverage enhancement configuration while in the URLLC coverage area and uses the URLLC configuration to transmit data associated with URLLC traffic to the base station.

21. The method of claim 20, further comprising:
after the UE moves out of the URLLC coverage area, receiving, from the UE, a second indicator indicating that the UE is outside the URLLC coverage area, wherein the UE:
activates the coverage enhancement configuration while outside the URLLC coverage area,
releases the URLLC configuration, and
uses the eMBB configuration to transmit data associated with eMBB traffic to the base station.
